(19) United States
(12) Patent Application Publication
(10) Pub. No.: US 2026/0086438 A1
(43) Pub. Date: Mar. 26, 2026

(54) WATERPROOF HOUSING AND IMAGING APPARATUS

(71) Applicant: ARASHI VISION INC., Shenzhen (CN)

(72) Inventors: Yanrong ZHENG, Shenzhen (CN); Fei GAO, Shenzhen (CN); Li WANG, Shenzhen (CN)

(73) Assignee: ARASHI VISION INC., Shenzhen (CN)

(21) Appl. No.: 19/408,364

(22) Filed: Dec. 4, 2025

Related U.S. Application Data
(63) Continuation of application No. PCT/CN2023/099527, filed on Jun. 9, 2023.

(51) Int. Cl. G03B 17/08

(52) U.S. Cl. CPC G03B 17/08

(57) ABSTRACT

In some aspects, a waterproof housing is provided. The waterproof housing includes a shell structure and one or more light-transmitting portions. The shell structure is provided with an accommodating cavity and includes one or more view-finding windows in communication with the accommodating cavity. The one or more light-transmitting portions are configured to seal and correspond to the one or more view-finding windows, and each includes a light-entrance surface. One of the one or more light-transmitting portions is configured to refract at least a portion of an incident light beam, forming an angle greater than 90 degrees relative to an optical axis of the one of the one or more light-transmitting portions, from the light-entrance surface to the one or more view-finding windows.

### CROSS-REFERENCE TO RELATED APPLICATION

This application is a continuation of International Application No. PCT/CN2023/099527, filed on Jun. 9, 2023. The entire content of this application is hereby incorporated by reference in its entirety.

### BACKGROUND

The present disclosure relates to the technical field of panoramic imaging apparatuses, and particularly relates to waterproof housing and imaging apparatus.

With the continuous improvement of people's living standards, the requirements for imaging apparatuses are also increasing. In related technologies, dual-lens panoramic imaging apparatuses have emerged to meet the panoramic imaging experience. Dual-lens panoramic imaging apparatuses usually use two lenses placed back-to-back, each lens having at least a 180° field of view. After capturing images with the two lenses, the images from the two lenses are stitched into a panoramic image by an algorithm. When performing underwater imaging operations, panoramic imaging apparatuses usually need to be equipped with a diving housing to provide waterproof protection.

However, in traditional panoramic imaging apparatuses, when performing underwater imaging operations, the diving housing easily blocks light, resulting in blind spots in view-finding, making it difficult to meet the light collection requirements for panoramic imaging.

### SUMMARY

According to various embodiments of the present disclosure, waterproof housing and imaging apparatus are provided.

A waterproof housing is provided, including:
a shell structure, provided with an accommodating cavity and including one or more view-finding windows in communication with the accommodating cavity; and
one or more light-transmitting portions, configured to seal and correspond to the one or more view-finding windows and each including a light-entrance surface, one of the one or more light-transmitting portions being configured to refract at least a portion of an incident light beam, forming an angle greater than 90 degrees relative to an optical axis of the one of the one or more light-transmitting portions, from the light-entrance surface to the one or more view-finding windows,
where one of the shell structure or the one of the one or more light-transmitting portions is provided with a raised portion for connection to another one of the shell structure or the one of the one or more light-transmitting portions; and
where the raised portion is configured to enable an effective light-entrance aperture of the light-entrance surface to be higher than an outer surface of the shell structure in a direction radially outward along the optical axis of the one of the one or more light-transmitting portions.

An imaging apparatus is provided, including an imaging device and a waterproof housing. The waterproof housing includes:
a shell structure, provided with an accommodating cavity and including one or more view-finding windows in communication with the accommodating cavity; and
one or more light-transmitting portions, configured to seal and correspond to the one or more view-finding windows and each including a light-entrance surface, one of the one or more light-transmitting portions being configured to refract at least a portion of an incident light beam, forming an angle greater than 90 degrees relative to an optical axis of the one of the one or more light-transmitting portions, from the light-entrance surface to the one or more view-finding windows.

A waterproof housing is provided, including:
at least two light-transmitting portions, with partially overlapping fields of view, a total coverage of non-overlapping fields of view of the at least two light-transmitting portions being equal to 360 degrees, wherein;
   each of the at least two light-transmitting portions includes a convex light-entrance surface and a concave light-exit surface, and
   a thickness of one of the at least two light-transmitting portions at an effective light-entrance aperture is greater than a central thickness of the one of the at least two light-transmitting portions;
a sealing assembly, in a sealed connection with the at least two light-transmitting portions, the sealing assembly and the at least two light-transmitting portions jointly enclosing a sealed cavity; and
a mounting member, positioned within the sealed cavity and corresponding to a junction of the at least two light-transmitting portions, the mounting member being configured to mount an imaging device.

An imaging apparatus is provided, including an imaging device and the waterproof housing as described above, the imaging device being arranged on the mounting member.

Details of one or more embodiments of the present disclosure are set forth in the accompanying drawings and the description below. Other features, objectives, and advantages of the application will become apparent from the description, the drawings, and the claims.

### BRIEF DESCRIPTION OF DRAWINGS

In order to more clearly illustrate the technical solutions in the embodiments of the present disclosure or the related art, the drawings required for the description of the embodiments or the related art will be briefly introduced below. Obviously, the drawings described below are only some embodiments of the present disclosure. For those skilled in the art, other drawings can also be obtained according to the disclosed drawings without creative efforts.

FIG. 1 is a schematic structural diagram of a waterproof housing according to some embodiments of the present disclosure.

FIG. 2 is a schematic sectional view of a portion of the waterproof housing according to some embodiments of the present disclosure.

FIG. 3 is a schematic structural diagram of a light-transmitting portion according to some embodiments of the present disclosure.

FIG. 4 is a schematic structural diagram of another waterproof housing according to some embodiments of the present disclosure.

FIG. 5 is a schematic sectional view of another waterproof housing according to some embodiments of the present disclosure.

FIG. 6 is a schematic structural diagram of another light-transmitting portion according to some embodiments of the present disclosure.

FIG. 7 is a schematic structural diagram of still another waterproof housing according to some embodiments of the present disclosure.

FIG. 8 is a schematic sectional view of still another waterproof housing according to some embodiments of the present disclosure.

FIG. 9 is a schematic structural diagram of still another light-transmitting portion according to some embodiments of the present disclosure.

FIG. 10 is a schematic structural diagram of yet another imaging apparatus according to some embodiments of the present disclosure.

FIG. 11 is an exploded schematic diagram of the imaging apparatus shown in FIG. 10.

FIG. 12 is a schematic sectional view of the imaging apparatus shown in FIG. 10.

FIG. 13 is a partially enlarged schematic diagram of a first sealing member in the imaging apparatus shown in FIG. 10.

FIG. 14 is a partially enlarged schematic diagram of a light-transmitting portion in the imaging apparatus shown in FIG. 10.

FIG. 15 is a schematic structural diagram of a light-transmitting portion in the imaging apparatus shown in FIG. 10.

The present disclosure will be described with reference to the accompanying drawings.

### DETAILED DESCRIPTION

The following will provide a clear and complete description of the technical solutions in the embodiments of the present disclosure with reference to the accompanying drawings in the embodiments of the present disclosure. Obviously, the described embodiments are only part of the embodiments of the present disclosure and not all embodiments. Based on the embodiments in the present disclosure, all other embodiments obtained by those of ordinary skill in the art without creative efforts shall fall within the protection scope of the present disclosure.

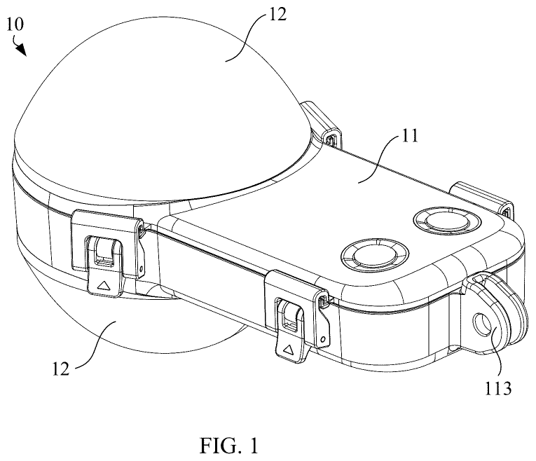

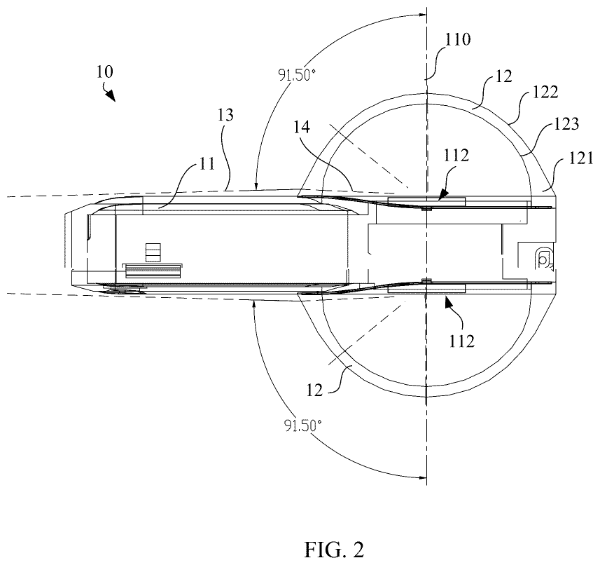

Please refer to FIG. 1 and FIG. 2. FIG. 1 is a schematic structural diagram of a waterproof housing 10 according to some embodiments, and FIG. 2 is a schematic sectional view of a portion of the structure of the waterproof housing 10 according to some embodiments. FIG. 2 may be a longitudinal sectional view taken along a center line of the waterproof housing 10. The waterproof housing 10 provided by the present disclosure can be configured to accommodate an imaging device to jointly form an imaging apparatus with the imaging device. The imaging device may include but is not limited to a panoramic camera, an action camera, and the like. The waterproof housing 10 can provide waterproof protection for the imaging device, and can also receive external view-finding light and refract the external view-finding light to the camera of the panoramic camera inside the waterproof housing 10, so that the imaging apparatus can perform underwater imaging functions.

Further, in some embodiments, the waterproof housing 10 may include a shell structure 11 and a light-transmitting portion 12. An accommodating cavity is provided inside the shell structure 11, and the imaging device can be accordingly accommodated in the accommodating cavity. The shell structure 11 is further provided with a view-finding window 112 in communication with the accommodating cavity. When the imaging device is accommodated in the accommodating cavity, the camera of the imaging device is arranged to correspond to the view-finding window 112, so as to receive external view-finding light through the view-finding window 112, and the rest of the imaging device is sealed by the shell structure 11. The light-transmitting portion 12 is configured to seal and correspond to the view-finding window 112, and the light-transmitting portion 12 and the shell structure 11 jointly realize the waterproof sealing of the imaging device. The light-transmitting portion 12 may include a light-entrance surface 122 and a light-exit surface 123 arranged opposite to each other. The light-exit surface 123 is arranged facing the view-finding window 112, and the light-transmitting portion 12 is configured to refract at least a portion of an incident light beam 13, forming an angle greater than 90 degrees relative to its optical axis 110, from the light-entrance surface 122 to the view-finding window 112.

Furthermore, in some embodiments, the number of view-finding windows 112 provided on the shell structure 11 is at least two, and the number of light-transmitting portions 12 is also at least two. The at least two light-transmitting portions 12 are arranged in a one-to-one correspondence with respective view-finding windows 112. The at least two light-transmitting portions 12 are configured to seal respective view-finding windows 112. The at least two light-transmitting portions 12 have partially overlapping fields of view with one another, and the total coverage of the non-overlapping fields of view of the at least two light-transmitting portions 12 is equal to 360 degrees.

The description that “non-overlapping fields of view of the at least two light-transmitting portions” add up to “360 degrees” may imply complete and exclusive coverage of the surrounding environment. The presence of overlapping between the fields of view, however, may indicate that images of certain areas can be captured by more than one portion. The partial overlapping between the fields of view of the at least two light-transmitting portions facilitates seamless panoramic coverage without blind spots. This overlapping region can allow image processing algorithms to align and stitch images from different optical paths with higher accuracy. More details will be given in the following context.

The above waterproof housing 10, when applied in an imaging apparatus having an imaging device, the cooperation or collaboration of the shell structure 11 and the light-transmitting portion 12 can effectively provide the accommodating cavity for accommodating the imaging device, thereby improving the waterproof performance of the imaging apparatus. Accordingly, the imaging apparatus can operate normally for underwater imaging, and prolonging the service life of the imaging apparatus.

At the same time, each light-transmitting portion 12 can be configured to refract at least a portion of the incident light beam 13 forming an angle greater than 90 degrees relative to the optical axis 110 to the view-finding window 112 for the imaging device to collect, so that the light-transmitting portion 12 can also have a sufficient field of view during underwater imaging operations. Consequently, it will not be unable to capture a panorama due to the occlusion of the shell structure 11, thereby meeting the light collection requirements for panoramic imaging.

It can be understood that the imaging device may refer to at least two cameras, and the cameras may be arranged in a one-to-one correspondence with the light-transmitting portions 12. The light-transmitting portions 12 can be configured to refract external light to the corresponding cameras. The total coverage of the non-overlapping fields of view of at least two light-transmitting portions 12 is equal to 360 degrees. There is an overlapping portion of the fields of view of the at least two light-transmitting portions 12, which can realize 360-degree panoramic imaging. The existence of the overlapping field of view also makes it easier to stitch images from multiple cameras into a panoramic image through algorithms. In addition, when the shell structure 11 or a supporting element (such as a selfie stick) connected to the shell structure 11 is located within the range of the overlapping field of view of the at least two light-transmitting portions 12, the shell structure 11 and the supporting element and other structures can also be hidden through applying suitable algorithms, thus avoiding the shell structure 11 and the supporting element and other structures from blocking the view-finding light or affecting the imaging effect.

In some embodiments, the number of the light-transmitting portions 12 can be two, the two light-transmitting portions 12 can face opposite directions, and the optical axes 110 of the two light-transmitting portions 12 coincide with each other. The imaging device may also include two cameras arranged back-to-back, each camera being arranged facing the light-exit surface 123 of a corresponding light-transmitting portion 12. When there are two light-transmitting portions 12, the field of view of each light-transmitting portion 12 is greater than or equal to 183 degrees. In other words, referring to FIG. 2, each light-transmitting portion 12 can at least refract a portion of the light beam, forming an angle greater than 91.5 degrees relative to the optical axis 110, to the view-finding window 112 for the camera to receive. With such a configuration, the two light-transmitting portions 12 have a sufficiently large field of view, and can cooperate to realize panoramic imaging.

At the same time, the two light-transmitting portions 12 also have sufficiently large overlapping fields of view to facilitate better panoramic image stitching by algorithms and hiding of the shell structure 11, supporting elements, and other structures. Of course, in other embodiments, the optical axes 110 of the two light-transmitting portions 12 may also be parallel to each other and arranged offset (for example, distant) from each other, to adapt to the diversified structural layouts of the imaging device and the shell structure 11, improving the design flexibility of the waterproof housing 10, as long as the two light-transmitting portions 12 can cooperate to realize panoramic imaging. It can be understood that the optical axis 110 of the light-transmitting portion 12 can be arranged to coincide with the optical axis of the corresponding camera.

It can be understood that when there are two light-transmitting portions 12, there may also be two cameras, and the multiple cameras can be used independently or simultaneously. When the two cameras are used simultaneously, the two cameras with a field of view greater than 180 degrees are arranged back-to-back to capture images from opposite perspectives, and then the images with a 180-degree field of view captured are stitched together by suitable algorithms to obtain a panoramic image, for example, an image with a 360-degree field of view. The imaging device can take photos or record videos; accordingly, the stitched panoramic image can be a static picture or a dynamic video.

In some embodiments, the light-transmitting portion 12 can be configured to refract at least one incident light beam 13 into an emergent light beam 14, and the angle between the emergent light beam 14 and the incident light beam 13 is less than a first preset angle, as shown in FIG. 2. The term “first preset angle” can be an angle that is set according to actual precision requirements. In some embodiments, the first preset angle is less than or equal to 5 degrees. As a result, the emergent light beam 14 formed by refraction of the light beam by the light-transmitting portion 12 can be directed to the imaging device in a direction substantially parallel to the incident light beam 13, which is beneficial for suppressing image distortion and improving the imaging quality of the imaging device.

In some embodiments, taking the light-transmitting portion 12 as an aspherical lens as an example, the angle between the emergent light beam 14 and the incident light beam 13 being less than the first preset angle can be achieved by adjusting the curvature of the lens to meet the refraction requirements. Furthermore, in some embodiments, the first preset angle is less than or equal to 2 degrees, which can further improve the imaging quality of the imaging device. In some embodiments, the first preset angle is less than or equal to 1 degree, which can further improve the imaging quality of the imaging device. In some embodiments, the emergent light beam and the incident light beam are substantially parallel, for example, the first preset angle is 0 degrees.

In some embodiments, in a direction radially outward along the optical axis 110, for example, in the direction along the optical axis 110 from the camera toward the light-transmitting portion 12, the effective light-entrance aperture of the light-entrance surface 122 is higher than the outer surface of the shell structure 11, which enables the light-transmitting portion 12 to better receive light beams forming an angle greater than 90 degrees relative to the optical axis 110, and is less likely to be blocked by the shell structure 11, thereby increasing the field of view of the waterproof housing 10.

The term “effective light-entrance aperture” of the light-entrance surface 122 may be used to refer to the portion of the light-entrance surface 122 through which incident light rays, within the designed field of view and angle of incidence, can enter and be effectively refracted toward the imaging device (e.g., a camera).

In some embodiments, the distance between the light-entrance surface 122 and the outer surface of the shell structure 11 can be increased to make the effective light-entrance aperture of the light-entrance surface 122 higher than the outer surface of the shell structure 11. For example, in some embodiments, the light-transmitting portion 12 is provided with a raised portion 121 connected to the shell structure 11. The raised portion 121 can be integrally formed with the main body of the light-transmitting portion 12, or the shell structure 11 can be provided with a raised portion 121 connected to the light-transmitting portion 12, to increase the distance between the light-entrance surface 122 and the outer surface of the shell structure 11. When the raised portion 121 is provided on the shell structure 11, the raised portion 121 includes but is not limited to a boss or spacer connected to the end of the light-transmitting portion 12.

In some embodiments, in a direction radially outward along the optical axis 110, the effective light-entrance aperture of the light-entrance surface 122 is higher than the effective light-exit aperture of the light-exit surface 123, so that the light-transmitting portion 12 (on the top in FIG. 2) can refract light from a higher position to a lower position (in terms of the orientation of FIG. 2), so that the camera of the imaging device located at the lower position can better receive light, meeting the view-finding requirements for panoramic imaging. In some embodiments, due to the provision of the raised portion 121, in the direction of the optical axis 110, the height difference between the incident point of the incident light beam 13 and the outer surface of the shell structure 11 is greater than the height difference between the emergent point of the emergent light beam 14 and the outer surface of the shell structure 11, so that the imaging device does not need to protrude or excessively protrude from the outer surface of the shell structure 11 to receive the light refracted by the light-transmitting portion 12, which is beneficial for miniaturization of the waterproof housing 10, and also beneficial for the waterproof housing 10 to be compatible with most panoramic imaging devices.

In some embodiments, the shell structure 11 is arranged outside the range of the field of view of the light-transmitting portion 12. In some embodiments, a portion of the shell structure 11 is arranged outside the range of the field of view of the light-transmitting portion 12, and another portion is within the range of the overlapping field of view of at least two light-transmitting portions 12. The portion of the shell structure 11 outside the range of the field of view of the light-transmitting portion 12 will not block the light-transmitting portion 12 from collecting view-finding light, and the light-transmitting portion 12 will not collect images of the shell structure 11, while the portion of the shell structure 11 within the range of the overlapping field of view of at least two light-transmitting portions 12 can be hidden by algorithms, so that the final panoramic image does not include the portion of the shell structure 11, avoiding the shell structure 11 from affecting the imaging effect of the imaging device.

In some embodiments, the shell structure 11 may further include a connecting portion 113 connected to the main body of the shell structure 11, as shown in FIG. 1. The connecting portion 113 is configured to connect a supporting element such as a selfie stick, so that the user can hold the imaging apparatus by the supporting element. In some embodiments, when the connecting portion 113 is connected to the supporting element, the supporting element is within the range of the overlapping field of view of the at least two light-transmitting portions 12, or a portion of the supporting element is outside the range of the field of view of the light-transmitting portion 12, and another portion is within the range of the overlapping field of view of the at least two light-transmitting portions 12. As a result, the image of the portion of the supporting element outside the range of the field of view of the light-transmitting portion 12 will not be collected by the light-transmitting portion 12, and the image of the portion within the range of the overlapping field of view of at least two light-transmitting portions 12 can be hidden by algorithms, so that the panoramic image acquired by the imaging device does not include the portion of the supporting element, avoiding the supporting element from affecting the imaging effect of the imaging device.

In one embodiment, at least one of the light-entrance surface 122 or the light-exit surface 123 of the light-transmitting portion 12 is aspherical.

In some embodiments, both the light-entrance surface 122 and the light-exit surface 123 of the light-transmitting portion 12 are aspherical, which can improve the flexibility of the surface design of the light-transmitting portion 12, and is beneficial for adjusting the surface shape, the curvature at various positions, and the aspheric coefficients of the light-transmitting portion 12, so as to meet the refraction requirements of light while improving image clarity. Consequently, distortion can be reduced, and the field of view can be expanded, thereby improving imaging quality.

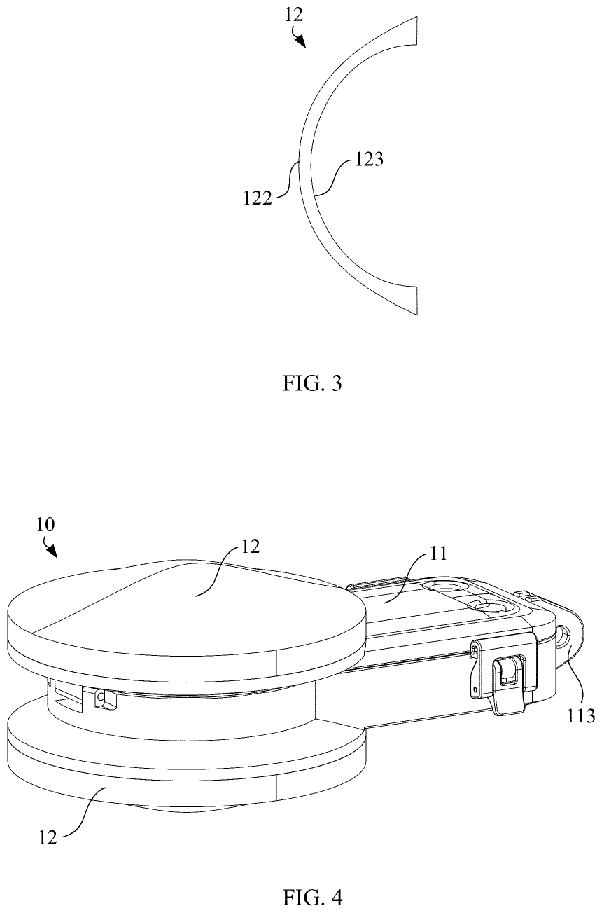

In combination with FIG. 1, FIG. 2, and FIG. 3, the light-entrance surface 122 is convex and aspherical, the light-exit surface 123 is concave and aspherical, and the thickness of the light-transmitting portion 12 at the effective light-entrance aperture is greater than the central thickness. With such a configuration, the shape of the light-transmitting portion 12 can be reasonably designed, which is beneficial for improving the ability of the light-transmitting portion 12 to deflect light beams at large angles, for example, the ability to deflect light beams forming an angle greater than 90 degrees relative to its optical axis 110. Accordingly, the light-transmitting portion 12 can refract at least a portion of the incident light beam 13 forming an angle greater than 90 degrees relative to the optical axis 110 to the view-finding window 112 for the imaging device to collect, so that the light-transmitting portion 12 can also have a sufficient field of view during underwater imaging operations, and will not be unable to capture a panorama due to the occlusion of the shell structure 11, thereby meeting the light collection requirements for panoramic imaging. Furthermore, in some embodiments, the ratio of the thickness of the light-transmitting portion 12 at the effective light-entrance aperture to the central thickness is greater than 1.5, so that the edge portion of the light-transmitting portion 12 has sufficient thickness to deflect light, thereby providing a sufficient field of view.

In the embodiments shown in FIG. 1 to FIG. 3, when there are two light-transmitting portions 12, the light-transmitting portion 12 can satisfy the following condition: 1.101≤R1/R2≤1.293, where R1 is the radius of curvature of the light-entrance surface 122 at the center (i.e., at the optical axis 110), and R2 is the radius of curvature of the light-exit surface 123 at the center (i.e., at the optical axis 110). When the above condition is satisfied, the radii of curvature of the light-entrance surface 122 and the light-exit surface 123 of the light-transmitting portion 12 can be reasonably configured. Accordingly, the light-entrance surface 122 and the light-exit surface 123 can form a good match, the light-entrance surface 122 can effectively deflect large-angle light to the light-exit surface 123, and the light-exit surface 123 can cooperate with the light-entrance surface 122 to reasonably configure the light collected by the light-entrance surface 122, thereby increasing the field of view of the light-transmitting portion 12 while suppressing distortion and other aberrations, and improving the imaging quality of the imaging apparatus.

In the embodiments shown in FIG. 1 to FIG. 3, when there are two light-transmitting portions 12, each light-transmitting portion 12 can also satisfy the following condition: 1.135<D1/D2≤1.333, where D1 is the effective light-entrance aperture of the light-entrance surface 122, and D2 is the effective light-exit aperture of the light-exit surface 123. When the above condition is satisfied, the effective apertures of the light-entrance surface 122 and the light-exit surface 123 can be reasonably configured. Accordingly, the light-transmitting portion 12 has a sufficient light collection range, which is beneficial for increasing the field of view of the light-transmitting portion 12 and meeting the requirements for panoramic imaging. At the same time, the step difference between the effective apertures of the light-entrance surface 122 and the light-exit surface 123 can be reduced, thereby suppressing distortion and other aberrations, and improving the imaging quality of the imaging apparatus.

In the embodiments shown in FIG. 1 to FIG. 3, when there are two light-transmitting portions 12, each light-transmitting portion 12 can also satisfy the following condition: 1.458≤Nd≤1.712, where Nd is the refractive index of the light-transmitting portion 12. When the above condition is satisfied, the light-transmitting portion 12 has sufficient refractive ability and can adapt to the application environment where the refractive index of water during underwater imaging is much higher than that of air. The light-transmitting portion 12 can also effectively refract large-angle light to the view-finding window 112 for the camera of the imaging device to receive during underwater imaging, thereby meeting the requirements for underwater panoramic imaging.

Referring to FIG. 3, in some embodiments, the parameters of the light-transmitting portion 12 are as shown in Table 1 below, where the first row of data is the parameter of the light-entrance surface 122, and the second row of data is the parameter of the light-exit surface 123. R is the radius of curvature of the corresponding surface at the center, D is the effective aperture of the corresponding surface, Nd is the refractive index of the light-transmitting portion 12, ABV is the Abbe number of the light-transmitting portion 12, and Conic is the conic constant of the corresponding surface.

TABLE 1

| Surface Type | R (mm) | D (mm) | Nd | ABV | Conic |
|---|---|---|---|---|---|
| Aspherical | 36.902 | 35.712503 | 1.585 | 29.9 | −0.440 |
| Aspherical | 30.833 | 28.933192 | | | 0.136 |

The aspheric coefficients of the light-transmitting portion 12 are given in Table 2 below, where K represents the conic constant, A4 represents the fourth-order aspheric coefficient, and A6 represents the sixth-order aspheric coefficient. In addition, the aspheric surface equation is as follows:

$$Z = \frac{c {r}^{2}}{1 + \sqrt{1 - ( K + 1 ) {c}^{2} {r}^{2}}} + {\sum }_{i} Ai {r}^{i}$$

where Z is the distance from the corresponding point on the aspheric surface to the plane tangent to the vertex of the surface, r is the distance from the corresponding point on the aspheric surface to the optical axis 110, c is the curvature of the aspheric surface at the vertex, K is the conic constant, and Ai is the coefficient corresponding to the i-th higher-order term in the aspheric surface equation.

It should be noted that the aspheric coefficients in Table 2 all provide a certain range of values, and the light-transmitting portion 12 can meet the refraction requirements of light as long as it satisfies the range shown in Table 2, thereby meeting the requirements for panoramic imaging. For example, the values at both ends or the middle value of the range can be selected.

TABLE 2

| Aspheric | | |
|---|---|---|
| Coefficient | Light-entrance surface | Light-exit surface |
| K | −4.75E−01 to −4.05E−01 | 1.25E−01 to 1.47E−01 |
| A4 | 4.98E−06 to 5.84E−06 | −1.79E−06 to −1.53E−06 |
| A6 | −4.67E−10 to −3.97E−10 | −7.92E−10 to −6.74E−10 |

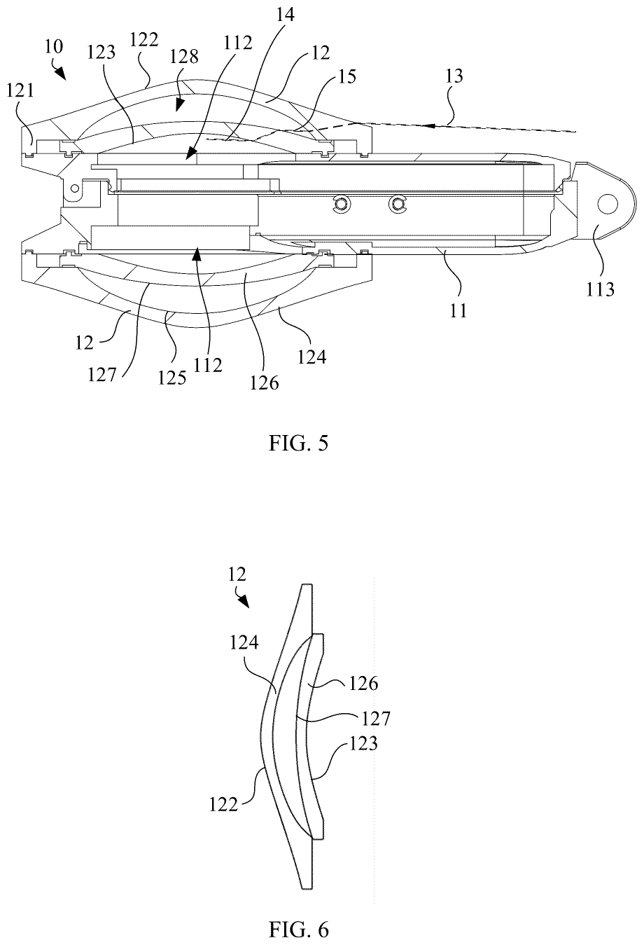

Please refer to FIG. 4, FIG. 5, and FIG. 6. In some embodiments, the light-transmitting portion 12 may include a first lens 124 and a second lens 126 disposed on the side of the first lens 124 facing the view-finding window 112. The light-transmitting portion 12 can be configured to refract at least a portion of the incident light beam 13 entering the first lens 124 into the emergent light beam 14 exiting the second lens, and both the first lens 124 and the second lens 126 can be lenses having optical power. The configuration of the first lens 124 and the second lens 126 in the light-transmitting portion 12 to cooperate in deflecting light is beneficial for improving the ability of the light-transmitting portion 12 to deflect large-angle light, thereby increasing the light collection range of the light-transmitting portion 12. As a result, the light-transmitting portion 12 can also have a sufficient field of view during underwater imaging operations, meeting the light collection requirements for panoramic imaging. In addition, the provision of two lenses in the light-transmitting portion 12 can not only collect large-angle light, but also allow the light to transition smoothly. This design can reduce the deflection angle of light at each surface of the light-transmitting portion 12, which is beneficial for suppressing aberrations and improving the imaging quality of the light-transmitting portion 12.

It can be understood that, as shown in FIG. 5, when the light-transmitting portion 12 is provided with a raised portion 121, the raised portion 121 can be provided at the end of the first lens 124 and connected to the shell structure 11, and when the shell structure 11 is provided with a raised portion 121, the raised portion 121 of the shell structure 11 can surround the first lens 124 and be connected to the end of the first lens 124, so as to raise the light-entrance surface 122 of the first lens 124. Accordingly, large-angle light can smoothly enter the first lens and is less likely to be blocked by the shell structure 11 or other structures.

In some embodiments, the first lens 124 can be configured to refract the incident light beam 13 into an intermediate light beam 15. In other words, after the incident light beam 13 enters the first lens 124, it is refracted by the first lens 124 to form the intermediate light beam 15 exiting the first lens 124. Subsequently, the intermediate light beam 15 can enter the second lens 126, and can be refracted by the second lens 126 to form the emergent light beam 14. The angle between the intermediate light beam 15 and the emergent light beam 14 is greater than the first preset angle, which is beneficial for the reasonable transition of light in the light-transmitting portion 12, and also enables the light-transmitting portion 12 to smoothly refract the incident light beam 13 into the emergent light beam 14. Accordingly, the angle between the incident light beam 13 and the emergent light beam 14 is less than the first preset angle, thereby suppressing aberrations such as distortion and improving the imaging quality of the imaging apparatus.

In some embodiments, the angle between the intermediate light beam 15 and the optical axis 110 of the light-transmitting portion 12 is greater than the angle between the emergent light beam 13 and the optical axis 110 of the light-transmitting portion 12. For example, the first lens 124 performs a first refraction on the incident light beam 13 to obtain the intermediate light beam 15, but the intermediate light beam 15 has not yet reached the target refraction angle, and the second lens 126 can further refract the intermediate light beam 15 to form the emergent light beam 14 that meets the target refraction angle. It can be understood that, in other embodiments, the deflection angle of the intermediate light beam 15 may have already exceeded the target refraction angle, and the second lens 126 then corrects the intermediate light beam 15 to form the emergent light beam 14 that meets the target refraction angle.

In some embodiments, in a direction radially outward along the optical axis 110, the incident point of the incident light beam 13 on the first lens 124 is higher than the emergent point of the intermediate light beam 15 on the first lens 124, and the incident point of the intermediate light beam 15 on the second lens 126 is higher than the emergent point of the emergent light beam 14 on the second lens 126. Accordingly, the light-transmitting portion 12 can reasonably refract light from a higher position through the first lens 124 and the second lens 126 to a lower position, so that the camera of the imaging device can smoothly receive the view-finding light, meeting the requirements for panoramic imaging.

FIG. 5 shows a sectional view of the waterproof housing 10 taken along a center line of the waterproof housing 10. Referring to FIG. 5, in some embodiments, the second lens 126 covers the view-finding window 112, and the edge of the first lens 124 is in contact with the edge of the second lens 126 to enclose and form a heat-insulating cavity 128, thereby preventing dust, water vapor, or other debris from entering the gap between the first lens 124 and the second lens 126, which is beneficial for improving the imaging effect of the imaging apparatus.

Furthermore, in some embodiments, the thermal conductivity of the medium such as air in the heat-insulating cavity 128 is lower than the thermal conductivity of the first lens 124 and the second lens 126. Thus, by spacing the first lens 124 and the second lens 126 apart and enclosing the heat-insulating cavity 128, the thermal conductivity between the light-entrance surface 122 of the first lens 124 and the light-exit surface 123 of the second lens 126 can be reduced, thereby enhancing the heat-insulating performance of the light-transmitting portion 12. It can be understood that when the waterproof housing 10 is used underwater, since the underwater temperature is relatively low and the heat generated by the imaging device causes the temperature inside the waterproof housing 10 to be higher than the external water temperature, although the temperature of the light-entrance surface 122 of the first lens 124 may be similar to the water temperature, due to the reduced thermal conductivity of the light-transmitting portion 12, the temperature of the emergent surface of the second lens 126 will not be too low, thus avoiding the situation where the temperature of the second lens 126 is lower than the temperature inside the accommodating cavity of the waterproof housing 10, which would cause fogging, and is beneficial for improving the imaging effect.

In some embodiments, the heat-insulating cavity 128 is in a vacuum state, or the heat-insulating cavity 128 can be filled with a heat-insulating medium. In some embodiments, the heat-insulating medium can include, but not limited to, a heat-insulating gas or another medium that does not affect the imaging effect. For example, it can be one or a combination of gases such as carbon dioxide, methane, argon, or krypton. It can be noted that when the waterproof housing 10 is a diving housing, the diving time may be as long as more than ten minutes. In some embodiments, setting the heat-insulating cavity 128 in a vacuum state can improve the heat-insulating effect and prevent water vapor in the heat-insulating cavity 128 from causing fogging on the first lens 124 or the second lens 126, thereby affecting the imaging quality.

In some embodiments, the average curvature of the internal refraction surface 125 (i.e., the inner surface of the first lens 124 facing the view-finding window 112) of the first lens 124 is greater than the average curvature of the external refraction surface 127 (i.e., the external surface of the second lens 126 facing away from the view-finding window 112) of the second lens 126. Accordingly, the spacing between the center of the first lens 124 and the second lens 126 is greater than the spacing between the edge of the first lens 124 and the second lens 126, so that in the direction parallel to the optical axis 110, the space in the middle portion of the heat-insulating cavity 128 is greater than the space at the edge. In other words, the heat-insulating cavity 128 is approximately almond-shaped. This is beneficial for increasing the volume of the heat-insulating cavity 128 and the spacing between the central parts of the first lens 124 and the second lens 126, thereby enhancing the heat-insulating performance of the light-transmitting portion 12 and improving the effect of suppressing fogging.

In some embodiments, at least one of the light-entrance surface 122, the internal refraction surface 125, the external refraction surface 127, or the light-exit surface 123 is aspherical.

In some embodiments, the first lens 124 has a light-entrance surface 122 and an internal refraction surface 125 arranged opposite to each other, the second lens 126 has an external refraction surface 127 and a light-exit surface 123 arranged opposite to each other, the internal refraction surface 125 and the light-exit surface 123 both face the view-finding window 112, the light-entrance surface 122, the internal refraction surface 125, the external refraction surface 127, and the light-exit surface 123 are all aspherical, the light-entrance surface 122 is convex, the internal refraction surface 125 is concave, the external refraction surface 127 is convex, and the light-exit surface 123 is concave. With such a configuration, the surface shapes of the various surfaces of the light-transmitting portion 12 can be reasonably designed. Accordingly, the light-transmitting portion 12 can reasonably deflect large-angle light, not only improving the ability of the light-transmitting portion 12 to collect light and thus increasing the field of view of the light-transmitting portion 12 to meet the requirements for panoramic imaging, but also enabling the first lens 124 and the second lens 126 to form a good match to smoothly transition the light, suppressing aberrations such as distortion, and improving the imaging quality of the imaging apparatus.

In some embodiments, when there are two light-transmitting portions 12, and the light-transmitting portion 12 is provided with two lenses having optical power, the light-transmitting portion 12 can satisfy the following condition. 1.028≤f1/f2≤2.011, where f1 is the focal length of the first lens 124, and f2 is the focal length of the second lens 126. When the above condition is satisfied, the focal lengths of the first lens 124 and the second lens 126 can be reasonably configured. Accordingly, the first lens has sufficient refractive power to deflect large-angle light, and at the same time, the first lens 124 and the second lens 126 can effectively cooperate to smoothly transition the light, suppressing aberrations such as distortion, and thus improving the imaging quality of the imaging apparatus.

In some embodiments, when there are two light-transmitting portions 12, and the light-transmitting portion 12 is provided with two lenses having optical power, the light-transmitting portion 12 can satisfy the following condition: 1.681≤DS1/DS4≤1.973, where DS1 is the effective light-entrance aperture of the light-entrance surface 122, and DS4 is the effective light-exit aperture of the light-exit surface 123. When the above condition is satisfied, the effective apertures of the light-entrance surface 122 and the light-exit surface 123 can be reasonably configured. Accordingly, the light-transmitting portion 12 has a sufficiently large aperture to receive large-angle light, meeting the requirements for panoramic imaging, and at the same time, the step difference between the effective apertures of the various surfaces of the light-transmitting portion 12 can be reduced, thereby suppressing aberrations such as distortion and improving the imaging quality of the imaging apparatus.

In some embodiments, when there are two light-transmitting portions 12, and the light-transmitting portion 12 is provided with two lenses having optical power, the light-transmitting portion 12 can satisfy the following condition. 1.371≤Nd1≤1.609; 1.371≤Nd2≤1.609, where Nd1 is the refractive index of the first lens 124, and Nd2 is the refractive index of the second lens 126. When the above condition is satisfied, the light-transmitting portion 12 has sufficient refractive ability, and can adapt to the application environment where the refractive index of water during underwater imaging is much higher than that of air, and can also effectively refract large-angle light to the view-finding window 112 for the camera of the imaging device to receive during underwater imaging, thereby meeting the requirements for underwater panoramic imaging.

Referring to FIG. 5, in some embodiments, the parameters of the light-transmitting portion 12 are as shown in Table 3 below, where the first row of data is the parameter of the light-entrance surface 122 of the first lens 124, the second row of data is the parameter of the external refraction surface 127 of the first lens 124, the third row of data is the parameter of the external refraction surface 127 of the second lens 126, and the fourth row of data is the parameter of the light-exit surface 123 of the second lens 126. R is the radius of curvature of the corresponding surface at the center, D is the effective aperture of the corresponding surface, Nd is the refractive index of the corresponding lens, ABV is the Abbe number of the corresponding lens, and Conic is the conic constant of the corresponding surface.

TABLE 3

| Surface Type | R (mm) | D (mm) | Nd | ABV | Conic |
|---|---|---|---|---|---|
| Aspherical | 27.695 | 47.5 | 1.49 | 57.32 | −8.079 |
| Aspherical | 45.491 | 31.4 | | | −2.949 |
| Aspherical | 98.694 | 32 | 1.49 | 57.32 | −0.808 |
| Aspherical | 46.329 | 26 | | | −6.875 |

The aspheric coefficients of the light-transmitting portion 12 are given in Table 4 below, where K represents the conic constant, A4 represents the fourth-order aspheric coefficient, A6 represents the sixth-order aspheric coefficient, A8 represents the eighth-order aspheric coefficient, and A10 represents the tenth-order aspheric coefficient. In addition, the aspheric surface equation is as follows:

$$Z = \frac{c {r}^{2}}{1 + \sqrt{1 - ( K + 1 ) {c}^{2} {r}^{2}}} + {\sum }_{i} Ai {r}^{i}$$

where Z is the distance from the corresponding point on the aspheric surface to the plane tangent to the vertex of the surface, r is the distance from the corresponding point on the aspheric surface to the optical axis 110, c is the curvature of the aspheric surface at the vertex, K is the conic constant, and Ai is the coefficient corresponding to the i-th higher-order term in the aspheric surface equation. It should be noted that the aspheric coefficients in Table 4 all provide a certain range of values, and the light-transmitting portion 12 can meet the refraction requirements of light as long as it satisfies the range shown in Table 4, thereby meeting the requirements for panoramic imaging. For example, the values at both ends or the middle value of the range can be selected.

TABLE 4

| | | Internal | External | |
|---|---|---|---|---|
| Aspheric | Light-entrance | refraction | refraction | Light-exit |
| Coefficient | surface 122 | surface 125 | surface 127 | surface 123 |
| K | −8.725 to | −3.185 to | −8.729E−01 to | −7.425 to −6.325 |
| | −7.433 | −2.713 | −7.435E−01 | |
| A4 | −2.203E−07 to | 1.043E−06 to | −1.108E−07 to | −6.185E−08 to |
| | −1.877E−07 | 1.225E−06 | −0.944E−07 | 5.269E−08 |
| A6 | −1.840E−11 to | −2.615E−09 to | 6.960E−11 to | −1.977E−10 to |
| | −1.568E−11 | −2.227E−09 | 8.170E−11 | 1.685E−10 |
| A8 | 0 | 4.204E−12 to | 5.758E−14 to | −1.121E−14 to |
| | | 4.936E−12 | 6.760E−14 | −0.955E−14 |
| A10 | −2.705E−18 to | 1.368E−16 to | 2.136E−17 to | 2.442E−16 to |
| | −2.305E−18 | 1.606E−16 | 2.508E−17 | 2.866E−16 |

In some embodiments, when the light-transmitting portion 12 is provided with two lenses, the light-transmitting portion 12 satisfies: the focal length f1 of the first lens 124 is −201.608 mm; the focal length f2 of the second lens 126 is −180.44 mm; and the focal length f of the light-transmitting portion 12 (i.e., the combined focal length of the first lens 124 and the second lens 126) is −93.15 mm.

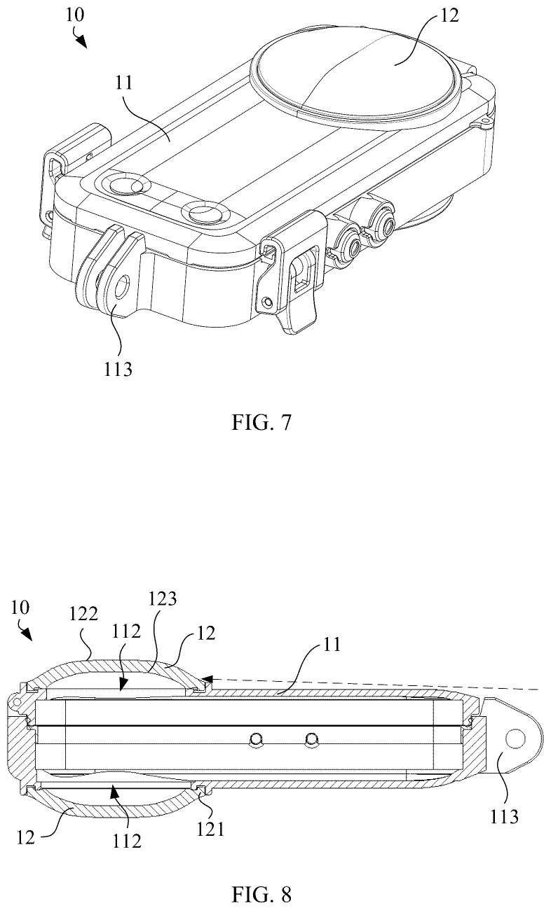

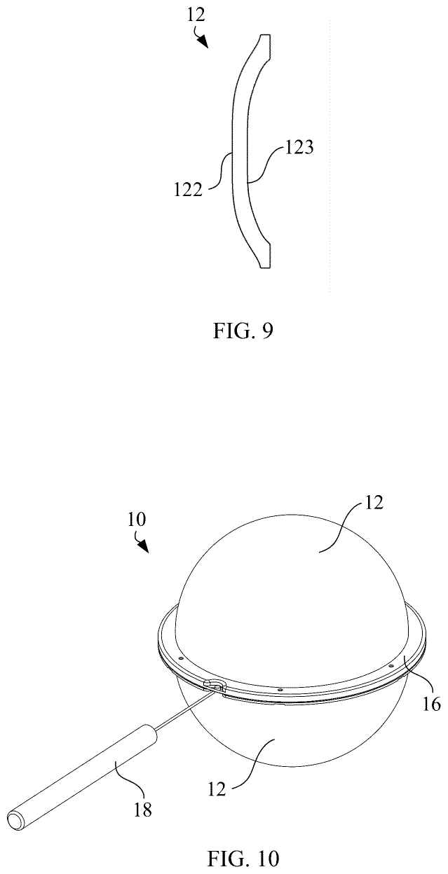

Please refer to FIG. 7, FIG. 8, and FIG. 9. In some embodiments, the light-transmitting portion 12 is substantially flat, and the direction of extension of the middle portion of the light-transmitting portion 12 is substantially parallel to a plane perpendicular to the optical axis. For example, the direction of extension of the portion of the light-transmitting portion 12 near the optical axis is substantially parallel to a plane perpendicular to the optical axis. With such a configuration, the volume of the light-transmitting portion 12 can be greatly reduced, thereby reducing the volume of the waterproof housing 10 and improving the user experience. Further, in some embodiments, the radii of curvature of the light-entrance surface 122 and the light-exit surface 123 of the light-transmitting portion 12 at the center (i.e., at the optical axis) are infinite, that is, the light-entrance surface 122 and the light-exit surface 123 at the center tend to be planar. Furthermore, in some embodiments, the shape of the light-entrance surface 122 at the circumference is convex, and the shape of the light-exit surface 123 at the circumference is concave. With such a configuration, the refractive ability of the light-transmitting portion 12 can be improved to increase the field of view of the light-transmitting portion 12 and meet the requirements for panoramic imaging, and at the same time, the light-transmitting portion 12 can be made substantially flat, which is beneficial for reducing the size of the light-transmitting portion 12 in the direction of the optical axis. Accordingly, the light-transmitting portion 12 does not protrude excessively from the shell structure 11, thereby improving the user experience and applicability of the waterproof housing 10.

In some embodiments, when there are two light-transmitting portions 12, each light-transmitting portion 12 satisfies the following condition. 1.159≤D1/D2≤1.361, where D1 is the effective light-entrance aperture of the light-entrance surface 122, and D2 is the effective light-exit aperture of the light-exit surface 123. When the above condition is satisfied, the effective apertures of the light-entrance surface 122 and the light-exit surface 123 can be reasonably configured. Accordingly, the light-transmitting portion 12 has a sufficient light collection range, which is beneficial for increasing the field of view of the light-transmitting portion 12 and meeting the requirements for panoramic imaging. At the same time, the step difference between the effective apertures of the light-entrance surface 122 and the light-exit surface 123 can be reduced, thereby suppressing aberrations such as distortion and improving the imaging quality of the imaging apparatus.

In some embodiments, when there are two light-transmitting portions 12, each light-transmitting portion 12 satisfies the following condition: 1.371≤Nd≤1.609, where Nd is the refractive index of the light-transmitting portion 12. When the above condition is satisfied, the light-transmitting portion 12 has sufficient refractive ability, and can adapt to the application environment where the refractive index of water during underwater imaging is much higher than that of air, and can also effectively refract large-angle light to the view-finding window 112 for the camera of the imaging device to receive during underwater imaging, thereby meeting the requirements for underwater panoramic imaging.

Referring to FIG. 8 and FIG. 9, in some embodiments, the parameters of the light-transmitting portion 12 are as shown in Table 5 below, where the first row of data is the parameter of the light-entrance surface 122, and the second row of data is the parameter of the light-exit surface 123. R is the radius of curvature of the corresponding surface at the center, D is the effective aperture of the corresponding surface, Nd is the refractive index of the light-transmitting portion 12, ABV is the Abbe number of the light-transmitting portion 12, and Conic is the conic constant of the corresponding surface.

TABLE 5

| Surface Type | R (mm) | D (mm) | Nd | ABV | Conic |
|---|---|---|---|---|---|
| Aspherical | Infinite | 24 | 1.49 | 57.32 | 33.251 |
| Aspherical | Infinite | 19.043 | | | 14.007 |

The aspheric coefficients of the light-transmitting portion 12 are given in Table 6 below, where K represents the conic constant, A4 represents the fourth-order aspheric coefficient, A6 represents the sixth-order aspheric coefficient, A8 represents the eighth-order aspheric coefficient, and so on. In addition, the aspheric surface equation is as follows:

$$Z = \frac{{cr}^{2}}{1 + \sqrt{1 - ( K + 1 ) {c}^{2} {r}^{2}}} + {\sum }_{i} {Air}^{i}$$

where Z is the distance from the corresponding point on the aspheric surface to the plane tangent to the vertex of the surface, r is the distance from the corresponding point on the aspheric surface to the optical axis 110, c is the curvature of the aspheric surface at the vertex, K is the conic constant, and Ai is the coefficient corresponding to the i-th higher-order term in the aspheric surface equation. It should be noted that the aspheric coefficients in Table 6 all provide a certain range of values, and the light-transmitting portion 12 can meet the refraction requirements of light as long as it satisfies the range shown in Table 6, thereby meeting the requirements for panoramic imaging, for example, the values at both ends or the middle value of the range can be selected.

TABLE 6

| Aspheric | | |
|---|---|---|
| Coefficient | Light-entrance surface | Light-exit surface |
| K | 30.591 to 35.911 | 12.886 to 15.128 |
| A4 | 2.544E−5 to 2.986E−5 | 2.968E−5 to 3.484E−5 |
| A6 | −2.995E−09 to −2.551E−09 | 2.446E−07 to 2.872E−07 |
| A8 | −6.184E−12 to −5.268E−12 | −1.388E−09 to −1.182E−09 |
| A10 | 3.176E−15 to 3.728 | −3.109E−13 to 2.649E−13 |
| A12 | −7.038E−17 to −5.996E−17 | 6.433E−15 to 7.551E−15 |
| A14 | 0 | −6.585E−19 to −5.609E−19 |
| A16 | 0 | −1.236E−20 to −1.052E−20 |

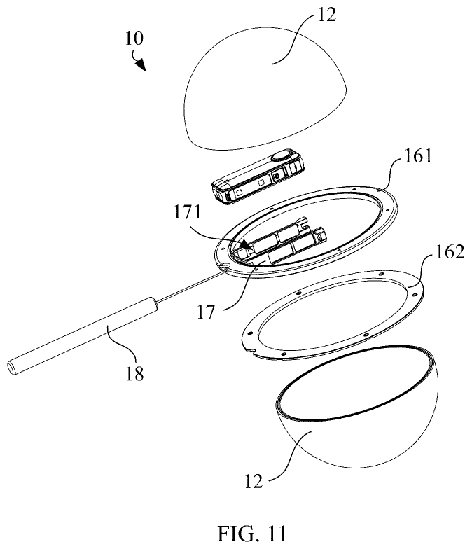

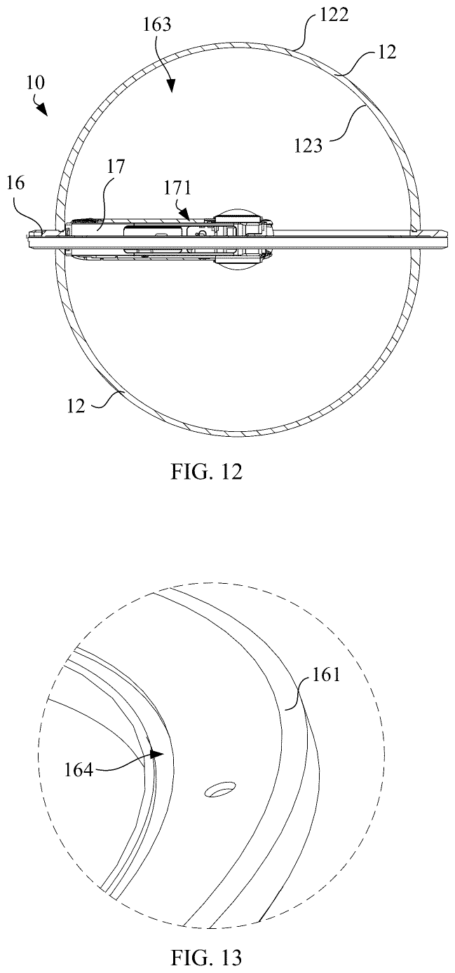

Please refer to FIG. 10, FIG. 11, and FIG. 12. In some embodiments, the waterproof housing 10 includes at least two light-transmitting portions 12, the at least two light-transmitting portions 12 have partially overlapping fields of view, and the total coverage of the non-overlapping fields of view of the at least two light-transmitting portions 12 is equal to 360 degrees. Each light-transmitting portion 12 has a light-entrance surface 122 and a light-exit surface 123 arranged opposite to each other, the light-exit surface 123 is arranged facing the imaging device, and the light-transmitting portion 12 can refract the light incident on the light-entrance surface 122 and emit it from the light-exit surface 123 for the camera of the imaging device to receive. The waterproof housing 10 further includes a sealing assembly 16 and a mounting member 17. The sealing assembly 16 is in a sealed connection with at least two light-transmitting portions 12, and the sealing assembly 16 and at least two light-transmitting portions 12 jointly enclose a sealed cavity 163. The mounting member 17 is accommodated in the sealed cavity 163 and is arranged at a position corresponding to the junction of the two light-transmitting portions 12. For example, the mounting member 17 is arranged at a position corresponding to the sealing assembly 16 in the direction of the optical axis. The mounting member 17 is used to mount the imaging device. In other words, when the imaging apparatus uses the light-transmitting portion 12 described in this embodiment, the imaging device is accommodated in the sealed cavity 163 formed by at least two light-transmitting portions 12 and the sealing assembly 16.

The above waterproof housing 10, when applied in an imaging apparatus having an imaging device, the cooperation of the two light-transmitting portions 12 and the sealing assembly 16 can effectively seal the imaging device, improving the waterproof performance of the imaging apparatus. Accordingly, the imaging apparatus can operate normally for underwater imaging, and prolonging the service life of the imaging apparatus. At the same time, by accommodating the imaging device in the sealed space formed by the two light-transmitting portions 12 and the sealing assembly 16, the two light-transmitting portions 12 can replace the traditional diving housing, and while improving the waterproof performance, can also avoid the situation where the diving housing blocks light to the greatest extent, which is beneficial for realizing panoramic imaging. In addition, the configuration of the light-transmitting portion 12 accommodating the imaging device enables the light-transmitting portion 12 to have a sufficiently large light collection area, which is beneficial for reducing the burden of the light-transmitting portion 12 in deflecting light, and while improving the ability of the light-transmitting portion 12 to collect large-angle light, can also reduce the design and manufacturing difficulty of the light-transmitting portion 12.

It can be understood that the imaging device may include at least two cameras, and the at least two cameras are arranged in a one-to-one correspondence with the at least two light-transmitting portions 12 to receive the light deflected by the corresponding light-transmitting portion 12. The at least two light-transmitting portions 12 have partially overlapping fields of view, and the total coverage of the non-overlapping fields of view of the at least two light-transmitting portions 12 is equal to 360 degrees. The at least two light-transmitting portions 12 can cooperate to realize panoramic imaging, and the existence of the overlapping field of view makes it easier to stitch images acquired by different cameras into a panoramic image through algorithms, and can also hide components located within the range of the overlapping field of view in the imaging apparatus through algorithms, improving the panoramic imaging effect. The mounting member 17 is arranged at the junction of the two light-transmitting portions 12. Accordingly, the mounting member 17 is less likely to block the view-finding light, thereby better realizing panoramic imaging, and can also make the portion of the mounting member 17 located within the field of view be within the range of the overlapping field of view of at least two light-transmitting portions 12, so that the mounting member 17 can be hidden through algorithms, improving the imaging effect.

It can be understood that the multiple cameras of the imaging device can be used independently or simultaneously. When the two cameras are used simultaneously, two cameras with a field of view greater than 180 degrees are arranged back-to-back to capture images from opposite perspectives, and then the images with a 180-degree field of view captured are stitched together by algorithms to obtain a panoramic image, that is, an image with a 360-degree field of view. The imaging device can take photos or record videos, so the stitched panoramic image can be a static picture or a dynamic video.

In some embodiments, the waterproof housing 10 is provided with two light-transmitting portions 12, the end surfaces of the two light-transmitting portions 12 are arranged opposite to each other, and the sealing assembly 16 is arranged between the two light-transmitting portions 12 and is in a sealed connection with the two light-transmitting portions 12, respectively. When there are two light-transmitting portions 12, the two light-transmitting portions 12 can be arranged back-to-back and their optical axes coincide. Accordingly, the images collected by the two light-transmitting portions 12 can be better stitched into a panoramic image by algorithms. Further, in some embodiments, the field of view of each light-transmitting portion 12 is greater than or equal to 183 degrees. In other words, each light-transmitting portion 12 can at least refract a portion of the light beam forming an angle greater than 91.5 degrees relative to the optical axis 110 to the view-finding window 112 for the camera to receive. With such a configuration, the two light-transmitting portions 12 have a sufficiently large field of view, and can cooperate with each other to realize panoramic imaging. At the same time, the two light-transmitting portions 12 also have a sufficiently large overlapping field of view to facilitate better panoramic image stitching by algorithms and hiding of components located within the range of the overlapping field of view. It can be understood, in other embodiments, the optical axes of the two light-transmitting portions 12 may also be parallel to each other and arranged offset from each other, to adapt to the diversified structural layouts of the imaging device and the shell structure 11, improving the design flexibility of the waterproof housing 10, as long as the two light-transmitting portions 12 can cooperate to realize panoramic imaging. It can be understood that the optical axis 110 of the light-transmitting portion 12 can be arranged to coincide with the optical axis of the corresponding camera.

Referring to FIG. 11, in some embodiments, the sealing assembly 16 includes a first sealing member 161 and a second sealing member 162, the first sealing member 161 and the second sealing member 162 are arranged opposite to each other and are in a sealed connection to each other, the side of the first sealing member 161 facing away from the second sealing member 162 is in a sealed connection with one of the sealing members, and the side of the second sealing member 162 facing away from the first sealing member 161 is in a sealed connection with the other light-transmitting portion 12. Accordingly, the sealing assembly 16 and the two light-transmitting portions 12 can provide a good sealing and waterproof effect for the imaging device located in the sealed cavity 163. The first sealing member 161 and the second sealing member 162 can be substantially annular to adapt to the shape of the end surface of the light-transmitting portion 12, and the materials of the first sealing member 161 and the second sealing member 162 include but are not limited to any suitable materials such as metal, plastic, and so on. In some embodiments, a sealing ring can also be provided between the first sealing member 161 and the second sealing member 162 to improve the sealing and waterproof performance between the first sealing member 161 and the second sealing member 162. The material of the sealing ring includes but is not limited to rubber and the like.

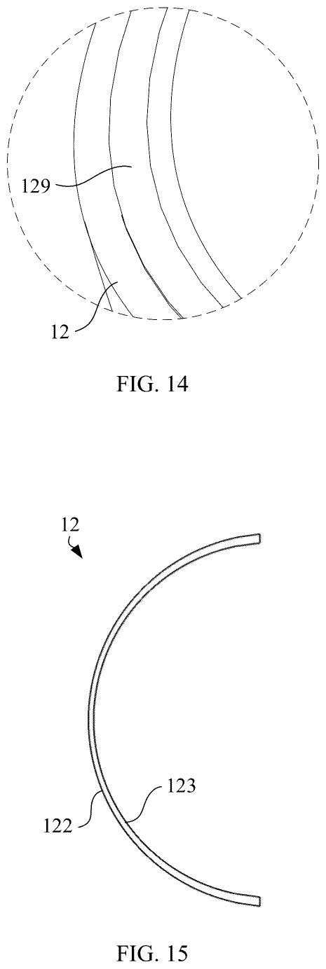

In combination with FIG. 11, FIG. 13, and FIG. 14, FIG. 13 shows an enlarged layout diagram of the first sealing member 161 in some embodiments, and FIG. 14 shows a partial enlarged schematic diagram of the light-transmitting portion 12 in some embodiments. In some embodiments, both the side of the first sealing member 161 facing away from the second sealing member 162 and the side of the second sealing member 162 facing away from the first sealing member 161 are provided with a clamping groove 164, the light-transmitting portion 12 includes a lens body and a clamping structure 129 provided on the end surface of the lens body, and the clamping structures 129 of the two light-transmitting portions 12 are embedded one-to-one in the two clamping grooves 164 of the sealing assembly 16. With such a configuration, the sealing performance of the connection between the light-transmitting portion 12 and the sealing assembly 16 can be improved, so that the cooperation of the light-transmitting portion 12 and the sealing assembly 16 can provide a better sealing effect for the imaging device located in the sealed cavity 163, thereby better adapting to underwater imaging scenarios.

It can be understood that the sealing assembly 16 is arranged between the two light-transmitting portions 12, and can effectively seal the gap between the two light-transmitting portions 12, and at the same time, is less likely to block the field of view of the light-transmitting portion 12. Accordingly, the light-transmitting portion 12 has a sufficient field of view to meet the requirements for panoramic imaging. In some embodiments, the sealing assembly 16 is located within the range of the overlapping field of view of at least two light-transmitting portions 12, so that the sealing assembly 16 can be hidden by algorithms, improving the imaging effect of the imaging apparatus. In other embodiments, a portion of the sealing assembly 16 is located within the range of the overlapping field of view of at least two light-transmitting portions 12, so that this portion can be hidden by algorithms, and another portion of the sealing assembly 16 is located outside the range of the field of view of the light-transmitting portion 12, so that the imaging device will not capture the portion of the sealing assembly 16 located outside the field of view, which is also beneficial for improving the imaging effect of the imaging apparatus.

In some embodiments, the waterproof housing 10 may further include a supporting element 18 connected to the sealing assembly 16. The supporting element 18 can be a selfie stick, and the provision of the supporting element 18 is beneficial for the user to hold the supporting element 18 for imaging. The supporting element 18 can pass through the first sealing member 161 and the second sealing member 162, and the end is connected to the imaging device, so that the imaging device can be operated through the supporting element 18. In some embodiments, the supporting element 18 is located within the range of the overlapping field of view of at least two light-transmitting portions 12, so that the supporting element 18 can be hidden by algorithms. Accordingly, the panoramic image acquired by the imaging device does not include the portion of the supporting element 18, which is beneficial for improving the imaging effect. In other embodiments, the supporting element 18 may also be partially located within the range of the overlapping field of view of at least two light-transmitting portions 12, so that this portion can be hidden by algorithms, and another portion of the supporting element 18 may be located outside the range of the field of view of the light-transmitting portion 12. Accordingly, the imaging device will not capture the portion of the supporting element 18 located outside the field of view, which is also beneficial for improving the imaging effect.

In some embodiments, the mounting member 17 is connected to the sealing assembly 16 and is arranged at a position corresponding to the sealing assembly 16 on the optical axis, and the mounting member 17 is provided with a positioning groove 171 for fixing the imaging device. Thus, when the imaging device is fixed to the mounting member 17, both the mounting member 17 and the imaging device are located at the junction of the two light-transmitting portions 12, and are less likely to block the field of view of the light-transmitting portion 12, and the mounting member 17 is also less likely to be captured by the imaging device, which is beneficial for improving the panoramic imaging effect. The specific configuration of the mounting member 17 is not limited. In some embodiments, the mounting member 17 can be a substantially U-shaped frame structure, and the mounting member 17 can surround three sides of the imaging device to fix the imaging device. It can be understood that, the configuration of the mounting member 17 is not limited to this, and the mounting member 17 can also cover portions of the imaging device other than the light-transmitting portion 12 and buttons, so as to provide good protection for the imaging device, as long as the mounting member 17 can fix the imaging device in the sealed cavity 163 and does not affect the light-transmitting portion 12 from collecting view-finding light. The material of the mounting member 17 includes, but is not limited to, plastic, metal, and so on.

It can be understood that, in some embodiments, as the light-transmitting portion 12 serves as the main body for accommodating the imaging device rather than being sealed only at the camera of the imaging device, the light-transmitting portion 12 has a sufficiently large size, so the light-transmitting portion 12 has a sufficiently large light collection area, and can well receive large-angle light, for example, receive view-finding light forming an angle greater than 90 degrees relative to the optical axis, which is beneficial for reducing the refractive ability requirement of the light-transmitting portion 12. Thus, while meeting the requirements for panoramic imaging, both the light-entrance surface 122 and the light-exit surface 123 of the light-transmitting portion 12 can be configured as spherical surfaces, which is beneficial for reducing the design and manufacturing cost of the light-transmitting portion 12 while effectively protecting the imaging device. Furthermore, in some embodiments, the light-entrance surface 122 of the light-transmitting portion 12 is convex, and the light-exit surface 123 is concave, which can not only effectively deflect large-angle light, but also suppress aberrations such as distortion and improve the imaging quality of the imaging device.

In combination with FIG. 12 and FIG. 15, in some embodiments, when there are two light-transmitting portions 12, each light-transmitting portion 12 satisfies the following condition: 1<R1/R2≤1.137, where R1 is the radius of curvature of the light-entrance surface 122, and R2 is the radius of curvature of the light-exit surface 123. When the above condition is satisfied, the radii of curvature of the light-entrance surface 122 and the light-exit surface 123 of the light-transmitting portion 12 can be reasonably configured. Accordingly, the light-entrance surface 122 and the light-exit surface 123 can form a good match, the light-entrance surface 122 can effectively deflect large-angle light to the light-exit surface 123, and the light-exit surface 123 can cooperate with the light-entrance surface 122 to reasonably configure the light collected by the light-entrance surface 122, thereby increasing the field of view of the light-transmitting portion 12 while suppressing aberrations such as distortion and improving the imaging quality of the imaging apparatus.

In some embodiments, when there are two light-transmitting portions 12, each light-transmitting portion 12 satisfies the following condition: 1<D1/D2≤1.135, where D1 is the effective light-entrance aperture of the light-entrance surface 122, and D2 is the effective light-exit aperture of the light-exit surface 123. When the above condition is satisfied, the effective apertures of the light-entrance surface 122 and the light-exit surface 123 can be reasonably configured, so that the light-transmitting portion 12 has a sufficient light collection range, which is beneficial for increasing the field of view of the light-transmitting portion 12 and meeting the requirements for panoramic imaging. At the same time, the step difference between the effective apertures of the light-entrance surface 122 and the light-exit surface 123 can be reduced, thereby suppressing aberrations such as distortion and improving the imaging quality of the imaging apparatus.

In some embodiments, when there are two light-transmitting portions 12, each light-transmitting portion 12 satisfies the following condition: 1.458≤Nd≤1.712, where Nd is the refractive index of the light-transmitting portion 12. When the above condition is satisfied, the light-transmitting portion 12 has sufficient refractive ability, and can adapt to the application environment where the refractive index of water during underwater imaging is much higher than that of air, and can also effectively refract large-angle light to the view-finding window 112 for the camera of the imaging device to receive during underwater imaging, thereby meeting the requirements for underwater panoramic imaging.

Referring to FIG. 15, in some embodiments, the parameters of the light-transmitting portion 12 are as shown in Table 7 below, where the first row of data is the parameter of the light-entrance surface 122, and the second row of data is the parameter of the light-exit surface 123. R is the radius of curvature of the corresponding surface at the center, D is the effective aperture of the corresponding surface, Nd is the refractive index of the light-transmitting portion 12, and ABV is the Abbe number of the light-transmitting portion 12.

TABLE 7

| Surface Type | R (mm) | D (mm) | Nd | ABV |
|---|---|---|---|---|
| Spherical | 100 | 99.631 | 1.585 | 29.9 |
| Spherical | 95 | 94.799 | | |

The technical features of the above embodiments can be combined arbitrarily. For the sake of brevity, not all possible combinations of the technical features in the above embodiments are described, however, as long as there is no contradiction in the combination of these technical features, they should be considered to fall within the scope described in this specification.

The above embodiments only express several embodiments of the present disclosure, and the description is relatively specific and detailed, but should not be understood as limiting the scope of the patent application. It should be pointed out that, for those of ordinary skill in the art, several modifications and improvements can be made without departing from the concept of the present disclosure, and these all fall within the protection scope of the present disclosure. Therefore, the protection scope of the present patent application should be subject to the appended claims.

What is claimed is:

1. A waterproof housing, comprising:
a shell structure, provided with an accommodating cavity and comprising one or more view-finding windows in communication with the accommodating cavity; and
one or more light-transmitting portions, configured to seal and correspond to the one or more view-finding windows and each comprising a light-entrance surface, one of the one or more light-transmitting portions being configured to refract at least a portion of an incident light beam, forming an angle greater than 90 degrees relative to an optical axis of the one of the one or more light-transmitting portions, from the light-entrance surface to the one or more view-finding windows,
wherein one of the shell structure or the one of the one or more light-transmitting portions is provided with a raised portion for connection to another one of the shell structure or the one of the one or more light-transmitting portions; and
wherein the raised portion is configured to enable an effective light-entrance aperture of the light-entrance surface to be higher than an outer surface of the shell structure in a direction radially outward along the optical axis of the one of the one or more light-transmitting portions.

2. The waterproof housing according to claim 1, wherein:
a number of the one or more view-finding windows is at least two, a number of the one or more light-transmitting portions is at least two; and
each of the at least two light-transmitting portions is configured to seal a respective view-finding window, and the at least two light-transmitting portions have partially overlapping fields of view, with a total coverage of non-overlapping fields of view being equal to 360 degrees.

3. The waterproof housing according to claim 2, wherein:
the number of the one or more light-transmitting portions is two; and
the two light-transmitting portions face opposite directions, optical axes of the two light-transmitting portions are parallel or coincident, and a field of view of each light-transmitting portion of the two light-transmitting portions is greater than or equal to 183 degrees.

4. The waterproof housing according to claim 1, wherein the one or more light-transmitting portions are configured to refract at least one incident light beam into an emergent light beam, and an angle between the emergent light beam and the incident light beam is less than a first preset angle.

5. The waterproof housing according to claim 4, wherein the emergent light beam is substantially parallel to the incident light beam.

6. The waterproof housing according to claim 4, wherein:
the one of the one or more light-transmitting portions comprises a first lens and a second lens positioned on a side of the first lens facing the one or more view-finding windows; and
the one of the one or more light-transmitting portions is configured to refract at least a portion of the incident light beam entering the first lens into the emergent light beam exiting the second lens.

7. The waterproof housing according to claim 6, wherein the first lens is configured to refract the incident light beam into an intermediate light beam, and an angle between the intermediate light beam and the emergent light beam is greater than the first preset angle.

8. The waterproof housing according to claim 1, wherein:
the one of the one or more light-transmitting portions further comprises a light-exit surface arranged opposite to the light-entrance surface; and
an effective light-entrance aperture of the light-entrance surface is higher than an effective light-exit aperture of the light-exit surface in a direction radially outward along the optical axis of the one of the one or more light-transmitting portions.

9. The waterproof housing according to claim 1, wherein the shell structure is outside a range of a field of view of the one or more light-transmitting portions, or a portion of the shell structure is within a range of an overlapping field of view of the one or more light-transmitting portions.

10. The waterproof housing according to claim 1, wherein:
the shell structure is provided with a connecting portion, and the connecting portion is configured to connect a supporting element; and
when the connecting portion connects the supporting element, the supporting element is within a range of an overlapping field of view of the one or more light-transmitting portions, or a portion of the supporting element is within a range of an overlapping field of view of the one or more light-transmitting portions.

11. The waterproof housing according to claim 1, wherein:
the one of the one or more light-transmitting portions further comprises a light-exit surface arranged opposite to the light-entrance surface, at least one of the light-entrance surface or the light-exit surface being aspherical.

12. The waterproof housing according to claim 1, wherein:
the one of the one or more light-transmitting portions further comprises a light-exit surface arranged opposite to the light-entrance surface; and
the light-entrance surface is convex, the light-exit surface is concave, at least one of the light-entrance surface or the light-exit surface is aspherical, and a thickness of the one of the one or more light-transmitting portions at an effective light-entrance aperture is greater than a central thickness of the one of the one or more light-transmitting portions.

13. The waterproof housing according to claim 1, wherein:
the one of the one or more light-transmitting portions is substantially flat, and a direction of extension of a middle portion of the one of the one or more light-transmitting portions is substantially parallel to a plane perpendicular to the optical axis of the one of the one or more light-transmitting portions.

14. An imaging apparatus, comprising:
an imaging device; and
a waterproof housing, comprising:
a shell structure, provided with an accommodating cavity and comprising one or more view-finding windows in communication with the accommodating cavity; and
one or more light-transmitting portions, configured to seal and correspond to the one or more view-finding windows and each comprising a light-entrance surface, one of the one or more light-transmitting portions being configured to refract at least a portion of an incident light beam, forming an angle greater than 90 degrees relative to an optical axis of the one of the one or more light-transmitting portions, from the light-entrance surface to the one or more view-finding windows.

15. A waterproof housing, comprising:
at least two light-transmitting portions, with partially overlapping fields of view, a total coverage of non-overlapping fields of view of the at least two light-transmitting portions being equal to 360 degrees, wherein;
each of the at least two light-transmitting portions comprises a convex light-entrance surface and a concave light-exit surface, and
a thickness of one of the at least two light-transmitting portions at an effective light-entrance aperture is greater than a central thickness of the one of the at least two light-transmitting portions;
a sealing assembly, in a sealed connection with the at least two light-transmitting portions, the sealing assembly and the at least two light-transmitting portions jointly enclosing a sealed cavity; and
a mounting member, positioned within the sealed cavity and corresponding to a junction of the at least two light-transmitting portions, the mounting member being configured to mount an imaging device.

16. The waterproof housing according to claim 15, wherein:
the at least two light-transmitting portions consist of two light-transmitting portions, end surfaces of the two light-transmitting portions are arranged opposite to each other; and
the sealing assembly is positioned between the two light-transmitting portions and in a sealed connection with the two light-transmitting portions.

17. The waterproof housing according to claim 15, wherein the sealing assembly is within a range of an overlapping field of view of the at least two light-transmitting portions, or a portion of the sealing assembly is outside a range of the fields of view of the at least two light-transmitting portions.

18. The waterproof housing according to claim 15, further comprising:
a supporting element connected to the sealing assembly, wherein the supporting element is within a range of an overlapping field of view of the at least two light-transmitting portions, or a portion of the supporting element is outside a range of the fields of view of the at least two light-transmitting portions.

19. The waterproof housing according to claim 15, wherein the mounting member is connected to the sealing assembly and corresponds to a position of the sealing assembly on an optical axis of the at least two light-transmitting portions, and the mounting member is provided with a positioning groove for fixing an imaging device.

20. The waterproof housing according to claim 15, wherein a light-entrance surface of the at least two light-transmitting portions and a light-exit surface of the at least two light-transmitting portions are both spherical.
